(19) United States
(12) Patent Application Publication
(10) Pub. No.: US 2018/0194989 A1
(43) Pub. Date: Jul. 12, 2018

(54) Hedta Based Chelants Used with Divalent Brines, Wellbore Fluids including The Same and Methods of Use Thereof

(71) Applicant: M-I L.L.C., Houston, TX (US)

(72) Inventors: Clotaire-Marie EYAA ALLOGO, Sugar Land, TX (US); Raymond RAVITZ, Houston, TX (US); Balkrishna GADIYAR, Katy, TX (US); Juan-Carlos SANTAMARIA, Houston, TX (US)

(21) Appl. No.: 15/742,222

(22) PCT Filed: Jul. 6, 2016
(86) PCT No.: PCT/US2016/041025

§ 371 Date: Jan. 5, 2018

Related U.S. Application Data
(60) Provisional application No. 62/189,046, filed on Jul. 6, 2015.

(51) Int. Cl. C09K 8/528; C09K 8/05

(52) U.S. Cl. CPC C09K 8/528; C09K 2208/26; C09K 8/05

(57) ABSTRACT

Methods of breaking a filter cake in a wellbore may include circulating a breaker fluid into the wellbore, the breaker fluid having a (2-hydroxyethyl)ethylenediaminetriacetic acid (HEDTA) chelant, where the HEDTA chelant is used with divalent brine in the breaker fluid or in the filter cake.

### CROSS-REFERENCE TO RELATED APPLICATION

The present document is based on and claims priority to U.S. Provisional Application Ser. No. 62/189,046, filed Jul. 6, 2015, which is incorporated herein by reference in its entirety.

### BACKGROUND

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

One way of protecting the formation is by forming a filter cake on the surface of the subterranean formation. Filter cakes are formed when particles suspended in a wellbore fluid coat and plug the pores in the subterranean formation such that the filter cake prevents or reduce both the loss of fluids into the formation and the influx of fluids present in the formation. A number of ways of forming filter cakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity.

Upon completion of drilling, the filter cake and/or fluid loss pill may stabilize the wellbore during subsequent completion operations such as placement of a gravel pack in the wellbore. Additionally, during completion operations, when fluid loss is suspected, a fluid loss pill of polymers may be spotted into to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been accomplished, removal of filter cake (formed during drilling and/or completion) remaining on the sidewalls of the wellbore may be necessary. Although filter cake formation and use of fluid loss pills are essential to drilling and completion operations, the barriers can be a significant impediment to the production of hydrocarbon or other fluids from the well if, for example, the rock formation is still plugged by the barrier. Because filter cake is compact, it often adheres strongly to the formation and may not be readily or completely flushed out of the formation by fluid action alone.

The problems of efficient well clean-up and completion are a significant issue in all wells, and especially in open-hole horizontal well completions. The productivity of a well is somewhat dependent on effectively and efficiently removing the filter cake while minimizing the potential of water blocking, plugging, or otherwise damaging the natural flow channels of the formation, as well as those of the completion assembly.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a methods that includes circulating a pre-mixed wellbore fluid into the wellbore, where the pre-mixed wellbore fluid includes a brine containing divalent cations and a (2-hydroxyethyl)ethylenediaminetriacetic acid (HEDTA) chelant.

In another aspect, embodiments disclosed herein relate to a method of breaking a filter cake in a wellbore, where the method includes drilling a wellbore with a drilling fluid that includes a divalent brine, forming a filter cake including the divalent brine incorporated into the filter cake, and circulating a breaker fluid into the wellbore, where the breaker fluid includes a (2-hydroxyethyl)ethylenediaminetriacetic acid (HEDTA) chelant.

In another aspect, embodiments disclosed herein relate to breaker fluid that include brine containing divalent cations and (2-hydroxyethyl)ethylenediaminetriacetic acid (HEDTA) chelant.

Other aspects and advantages of the claimed subject matter will be apparent from the following description and the appended claims.

### DETAILED DESCRIPTION

In one aspect, embodiments disclosed herein are generally directed to chemical breaker and displacement fluids that are useful in the drilling, completing, and working over of subterranean wells, preferably oil and gas wells. In another aspect, embodiments disclosed herein are generally directed to the formulation of a breaker fluid. Specifically, embodiments may contain a (2-hydroxyethyl)ethylenediaminetriacetic acid (HEDTA) chelant and a divalent brine.

The removal of water-based filter cake has been conventionally achieved with water based treatments that include: an aqueous solution with an oxidizer (such as persulfate), a hydrochloric acid solution, organic (acetic, formic) acid, combinations of acids and oxidizers, and/or aqueous solutions containing enzymes. Chelating agents (e.g., ethylenediaminetetraacetic acid (EDTA)) have also been used to promote the dissolution of calcium carbonate present in the filter cake. According to traditional teachings, the oxidizer and enzyme attack the polymer fraction of the filter cake and the acids typically attack the carbonate fraction (and other minerals).

One of the most problematic issues facing filter cake removal involves the formulation of the clean-up or breaker fluid solutions that are both effective and stable. For example, one of the more common components in a filter cake is calcium carbonate, and a clean-up or breaker fluid solution would ideally include hydrochloric acid, which reacts very quickly with calcium carbonate. However, while effective in targeting calcium carbonate, such a strong acid is also reactive with any calcium carbonate in the formation (e.g., limestone), and it may be reactive or chemically incompatible with other desirable components of the clean-up solution. Further the clean-up or breaker fluid solution can penetrate into the formation, resulting in unanticipated losses, damage to the formation that subsequently result in only a partial clean-up or loss of well control.

Unintended side effects can also arise from combining the various chemicals used to form the clean-up solutions and using these solutions downhole to remove filter cakes. One such side effect is precipitation in the wellbore, particularly when divalent ions are present, either in the breaker fluid or in the filter cake. When precipitants form in the wellbore, they can clog the pumps and equipment intended to circulate the fluids and remove the filter cake. Various calcium salts are examples of a precipitant that may form in processes for removing filter cakes. While precipitation is just one example, the chemical compatibility of the components commonly used in breaker fluids may be less than ideal and can lead to a sudden and unforeseen breakdown in fluid properties before or during a wellbore operation. Accordingly, effective and stable clean up solutions or breaker fluids are highly sought after for efficient wellbore operations.

Chelants are often included in breaker fluid formulations to assist with the degradation and clearance of the calcium carbonate component of the filter cake from the sidewalls of the wellbore. As chelants are used as a reactive species, their formulation in breaker fluid formulations must be carefully controlled in order to not adversely interact with the other components in the breaker fluid system. Prevailing thought in breaker fluid formulation is that certain chelants should not be utilized in fluids containing divalent brines due to adverse reactions with the brine which may cause the formulation to not perform adequately when downhole. Indeed, chelants are commonly used to chelate divalent ions (Ca⁺²) present in filter cakes to aid in their degradation from the sidewalls of the wellbore. Thus, if divalent ions are already present in the brine carrying the chelants downhole, adverse reactions and reduced capability in degrading filter cake have conventionally been expected. While a chelant may theoretically sequester the calcium, many chelants cannot be dissolved in divalent brine-based breaker fluids, at the conditions in which the breaker fluids are used to break the filter cake.

Advantageously, inventors of the present disclosure have found that an HEDTA chelant may be compatible with divalent brines and may be used in a breaker fluid containing divalent brines or to break a filter cake formed from a divalent brine. Thus, embodiments of the present disclosure may use (2-hydroxyethyl)ethylenediaminetriacetic acid (also referred to as HEDTA) in the breaker fluid formulation. In one or more embodiments, the HEDTA may be present in the breaker fluid in an amount up to 35 percent by volume of the breaker fluid. In other embodiments, HEDTA may be present in an amount that ranges from 5 to 35 vol %, or at least 5, 10, 15 vol % and up to 15, 20, 25, 30, and 35 vol %, where any lower limit can be used with any upper limit.

To maintain compatibility, the density of the divalent brine may be limited, for example, to about 11.5 lb/gal for CaCl₂, to about 14.1 lb/gal for CaBr₂, and to about 19.0 lb/gal for ZnBr₂. In one or more embodiments, the density of the fluid may be about 5% below the saturation point of the divalent species or below about 3%, 2% or 1% in other embodiments.

The pH of the breaker fluid may also be less than 5, or less than 4 in one or more embodiments.

Breaker fluids in embodiments of this disclosure be emplaced in the wellbore using conventional techniques known in the art, and may be used in drilling, completion, workover operations, etc. Additionally, one skilled in the art would recognize that such wellbore fluids may be prepared with a large variety of formulations. Specific formulations may depend on the stage in which the fluid is being used, for example, depending on the depth and/or the composition of the formation. The breaker fluids described above may be adapted to provide improved breaker fluids under conditions of high temperature and pressure, such as those encountered in deep wells, where high densities are required. Breaker fluids may find particular use when the filter cake to be broken and/or the fluid present in the well contains a divalent brine for fluid compatibility. Further, one skilled in the art would also appreciate that other additives known in the art may be added to the breaker fluids of the present disclosure without departing from the scope of the present disclosure.

The types of filter cakes that the present breaker fluids may break include those formed from oil-based or water-based drilling fluids. That is, the filter cake may be either an oil-based filter cake (such as an invert emulsion filter cake produced from a fluid in which oil is the external or continuous phase) or a water-based (such as an aqueous filter cake in which water or another aqueous fluid is the continuous phase). It is also within the scope of the present disclosure that filter cakes may also be produced with direct emulsions (oil-in-water), or other fluid types.

As described above, the breaker fluid may be circulated in the wellbore during or after the performance of at least one completion operation. In other embodiments, the breaker fluid may be circulated either after a completion operation or after production of formation fluids has commenced to destroy the integrity of and clean up residual drilling fluids remaining inside casing or liners.

Generally, a well is often “completed” to allow for the flow of hydrocarbons out of the formation and up to the surface. As used herein, completion processes may include one or more of the strengthening the well hole with casing, evaluating the pressure and temperature of the formation, and installing the proper completion equipment to ensure an efficient flow of hydrocarbons out of the well or in the case of an injector well, to allow for the injection of gas or water. Completion operations, as used herein, may specifically include open hole completions, conventional perforated completions, sand exclusion completions, permanent completions, multiple zone completions, and drainhole completions, as known in the art. A completed wellbore may contain at least one of a slotted liner, a predrilled liner, a wire wrapped screen, an expandable screen, a sand screen filter, a open hole gravel pack, or casing, for example.

Breaker fluids as disclosed herein may also be used in a cased hole to remove any drilling fluid left in the hole during any drilling and/or displacement processes. Well casing may consist of a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice-versa), the fluid in the wellbore is displaced with a different fluid. For example, an oil-based mud may be displaced by another oil-based displacement to clean the wellbore. The oil-based displacement fluid may be followed with a water-based displacement fluid prior to beginning drilling or production. Conversely, when drilling with a water-based mud, prior to production, the water-based mud may be displacement water-based displacement, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning up a wellbore drilled with an oil based drilling fluid. In one such illustrative embodiment, the method involves circulating a breaker fluid disclosed herein in a wellbore, and then shutting in the well for a predetermined amount of time to allow penetration and fragmentation of the filter cake to take place. Upon fragmentation of the filter cake, the residual drilling fluid may be easily washed out of the wellbore. Alternatively, a wash fluid (different from the breaker fluid) may be circulated through the wellbore prior to commencing production.

The fluids disclosed herein may also be used in a wellbore where a screen is to be put in place downhole. After a hole is under-reamed to widen the diameter of the hole, drilling string may be removed and replaced with production tubing having a desired sand screen. Alternatively, an expandable tubular sand screen may be expanded in place or a gravel pack may be placed in the well. Breaker fluids may then be placed in the well, and the well is then shut in to allow penetration and fragmentation of the filter cake to take place. Upon fragmentation of the filter cake, the fluids can be easily produced from the wellbore upon initiation of production and thus the residual drilling fluid is easily washed out of the wellbore. Alternatively, a wash fluid (different from the breaker fluid) may be circulated through the wellbore prior to commencing production.

However, the breaker fluids disclosed herein may also be used in various embodiments as a displacement fluid and/or a wash fluid. As used herein, a displacement fluid is typically used to physically push another fluid out of the wellbore, and a wash fluid typically contains a surfactant and may be used to physically and chemically remove drilling fluid residue from downhole tubulars. When also used as a displacement fluid, the breaker fluids of the present disclosure may act effectively push or displace the drilling fluid. When also used as a wash fluid, the breaker fluids may assist in physically and/or chemically removing the filter cake once the filter cake has been disaggregated by the breaker system.

Further, in one or more embodiments, the present fluids may be incorporated into gravel packing carrier fluids, which is described, for example, in U.S. Pat. No. 6,631,764. Breaker fluids are typically used in cleaning the filter cake from a wellbore that has been drilled with either a water-based drilling mud or an invert emulsion based drilling mud. Breaker fluids are typically circulated into the wellbore, contacting the filter cake and any residual mud present downhole, may be allowed to remain in the downhole environment until such time as the well is brought into production. The breaker fluids may also be circulated in a wellbore that is to be used as an injection well to serve the same purpose (i.e. remove the residual mud and filter cake) prior to the well being used for injection of materials (such as water surfactants, carbon dioxide, natural gas, etc. . . . ) into the subterranean formation. Thus, the fluids disclosed herein may be designed to form two phases, an oil phase and a water phase, following dissolution of the filter cake be which can easily produced within the wellbore upon initiation of production. Regardless of the fluid used to conduct the under-reaming operation, the fluids disclosed herein may effectively degrade the filter cake and substantially remove the residual drilling fluid from the wellbore upon initiation of production.

As previously stated, it is also within the scope of the present disclosure that the present breaker components may be incorporated into a carrier fluid for gravel packing. Specific techniques and conditions for pumping a gravel pack composition into a well are known to persons skilled in this field. The conditions which can be used for gravel-packing in the present disclosure include pressures that are above fracturing pressure, particularly in conjunction with the Alternate Path Technique, known for instance from U.S. Pat. No. 4,945,991, and according to which perforated shunts are used to provide additional pathways for the gravel pack slurry. Furthermore, certain oil based gravel pack compositions of the present disclosure with relatively low volume internal phases (e.g., discontinuous phases) can be used with alpha- and beta-wave packing mechanisms similar to water packing.

Further, a wellbore contains at least one aperture, which provides a fluid flow path between the wellbore and an adjacent subterranean formation. In an open hole completed well, the wellbore's open end, that is abutted to the open hole, may be the at least one aperture. Alternatively, the aperture can comprise one or more perforations in the well casing. At least a part of the formation adjacent to the aperture has a filter cake coated on it, formed by drilling the wellbore with either a water- or oil-based wellbore fluid that deposits on the formation during drilling operations and comprises residues of the drilling fluid. The filter cake may also comprise drill solids, bridging/weighting agents, surfactants, fluid loss control agents, and viscosifying agents, etc. that are residues left by the drilling fluid. In particular embodiments, it is envisioned that the filter cake may include calcium carbonate bridging particles, which may be at least partially dissolved by the breaker fluid.

### EXAMPLES

The present examples demonstrate the applicability of an HEDTA breaker with a divalent brine.

### Example 1

In the first example, a variety of breaker types including a GLDA-based breaker, an acid precursor breaker, an aliphatic amino acid based breaker, and a EDTA-based breaker, compared to an HEDTA chelant all of which are available from M-I SWACO (Houston, Tex.) to show the general incompatibility of breakers with divalent brines, such as CaCl₂. The components were exposes to CaCl₂ at 250 F and precipitation was noted at various time intervals. The results are shown below in Table 1. As observed, only the HEDTA based chelant showed no precipitation during the 48 hours.

TABLE 1

| Component | Initial | 1.5 hr | 24 hrs | 48 hrs |
|---|---|---|---|---|
| GLDA breaker | NO | NO | LITTLE | LITTLE |
| acid precursor breaker | NO | YES | YES | YES |
| aliphatic amino acid | NO | YES | YES | YES |
| breaker | | | | |
| HEDTA chelant | NO | NO | NO | NO |
| EDTA chelant | NO | NO | YES+ | YES+ |

### Example 2

The objective of this example was to observe any compatibility between the HEDTA chelant and CaCl₂, CaBr₂ and CaCl₂/CaBr₂ brines at several densities. Specifically, the testing protocol included 1) mixing brines using dry salts, 2) filtrating the brine, 3) adding the HEDTA chelant, 4) observe initially (within 10 minutes) and after 24 hrs static aged at ambient temperature, 5) measure pH, 6) add calcium carbonate, 7) observe for any reaction. Observations of crystal or precipitated formation and changes in the color were parameters selected to evaluate the compatibility. Mixture of brines and HEDTA chelant determined to be compatible when the blend do not change color and precipitation did not occur. The mixture compositions and results are shown in Table 2 below.

TABLE 2

| | | Dry | Dry | | | |
|---|---|---|---|---|---|---|
| | Water | CaCl2 | CaBr2 | HEDTA | Density | |
| Test | (lb/bbl) | (lb/bbl) | (lb/bbl) | (lb/bbl) | (lb/gal) | Appearance |
| 1 | 156 | 189 | 363 | 69 | 15.3 | Salt Out |
| 2 | 162 | 189 | 245 | 92 | 15.3 | Salt Out |
| 3 | 168 | 189 | 127 | 116 | 15.3 | Salt Out |
| 4 | 173 | 189 | 0 | 139 | 11.8 | Milky |
| 5 | 145 | 129 | 363 | 92 | 15.3 | Salt Out |
| 6 | 186 | 129 | 245 | 69 | 15.3 | Milky |
| 7 | 180 | 129 | 127 | 139 | 14.3 | Cloudy |
| 8 | 221 | 129 | 0 | 116 | 11.3 | Clear |
| 9 | 139 | 69 | 363 | 116 | 15.3 | Salt Out |
| 10 | 157 | 69 | 245 | 139 | 15.3 | Cloudy |
| 11 | 244 | 69 | 127 | 69 | 12.6 | Clear |
| 12 | 262 | 69 | 0 | 92 | 9.9 | Clear |
| 13 | 151 | 0 | 363 | 139 | 15.3 | Cloudy |
| 14 | 204 | 0 | 245 | 116 | 14.2 | Clear |
| 15 | 233 | 0 | 127 | 92 | 11.4 | Clear |
| 16 | 286 | 0 | 0 | 69 | 8.3 | Clear |

Samples that showed salt out had concentrations of dry salts were above saturation, but were used to assess the compatibility between the HEDTA chelant and divalent brine (CaCl₂ and CaBr₂ salts). From this, the upper limit of brine density may be determined.

Additionally, the HEDTA chelant mixed with the divalent brines containing—calcium carbonate material were also tested, shown in Table 3 below.

TABLE 3

| | | | Dry | | | |
|---|---|---|---|---|---|---|
| | Water | Dry CaCl2 | CaBr2 | HEDTA | CaCO3 | Reaction |
| Test | (lb/bbl) | (lb/bbl) | (lb/bbl) | (lb/bbl) | (lb/bbl) | w/CaCO3 |
| 1 | 156 | 189 | 363 | 69 | 0 | No |
| 2 | 162 | 189 | 245 | 92 | 17 | No |
| 3 | 168 | 189 | 127 | 116 | 33 | No |
| 4 | 173 | 189 | 0 | 139 | 50 | Yes |
| 5 | 145 | 129 | 363 | 92 | 33 | No |
| 6 | 186 | 129 | 245 | 69 | 50 | Yes |
| 7 | 180 | 129 | 127 | 139 | 0 | Yes |
| 8 | 221 | 129 | 0 | 116 | 17 | Yes |
| 9 | 139 | 69 | 363 | 116 | 50 | No |
| 10 | 157 | 69 | 245 | 139 | 33 | Yes |
| 11 | 244 | 69 | 127 | 69 | 17 | Yes |
| 12 | 262 | 69 | 0 | 92 | 0 | Yes |
| 13 | 151 | 0 | 363 | 139 | 17 | Yes |
| 14 | 204 | 0 | 245 | 116 | 0 | Yes |
| 15 | 233 | 0 | 127 | 92 | 50 | Yes |
| 16 | 286 | 0 | 0 | 69 | 33 | Yes |

### Example 3

Similar to Example 2, the testing protocol included 1) mixing brines, 2) filtrating the brine, 3) add HEDTA chelant, 4) divide samples into two for static aging (one at ambient temperature and one at 38 F, 5) observe initially (within 10 minutes) and after 24 hrs static aged at ambient temperature and 38 F, 6) measure pH, 7) add calcium carbonate into samples that show compatibility at all temperatures, and 8) observe for any reaction. The mixture compositions and results are shown in Table 4 below.

TABLE 4

| | | Dry | | | | | | | |
|---|---|---|---|---|---|---|---|---|---|
| | Water | CaBr2 | HEDTA | CaCO3 | Density | | Initial | 24 hr. | 48 hr. |
| Test | (lb/bbl) | (lb/bbl) | (lb/bbl) | (lb/bbl) | (lb/gal) | pH | Obs. | Obs. | Obs. |
| 17 | 166 | 327 | 139 | 0 | 15.03 | 0 | OK | Prec. | Prec. |
| 18 | 178 | 327 | 116 | 16 | 15.01 | 0 | OK | Prec. | Prec. |
| 19 | 190 | 327 | 92 | 33 | 14.99 | 0 | OK | Prec. | Prec. |
| 20 | 201 | 327 | 69 | 49 | 14.96 | 0 | OK | Prec. | Prec. |
| 21 | 180 | 248 | 139 | 16 | 13.71 | 0.6 | OK | OK | OK |
| 22 | 203 | 248 | 116 | 0 | 13.48 | 0.6 | OK | OK | OK |
| 23 | 203 | 248 | 92 | 49 | 13.62 | 0.6 | OK | OK | OK |
| 24 | 227 | 248 | 69 | 33 | 13.39 | 0.6 | OK | OK | OK |
| 25 | 194 | 169 | 139 | 33 | 12.34 | 1.2 | OK | OK | OK |
| 26 | 205 | 169 | 116 | 49 | 12.27 | 1.2 | OK | OK | OK |
| 27 | 240 | 169 | 92 | 0 | 11.94 | 1.2 | OK | OK | OK |
| 28 | 252 | 169 | 69 | 16 | 11.86 | 1.2 | OK | OK | OK |
| 29 | 207 | 90 | 139 | 49 | 10.92 | 1.8 | OK | OK | OK |
| 30 | 231 | 90 | 116 | 33 | 10.74 | 1.8 | OK | OK | OK |
| 31 | 254 | 90 | 92 | 16 | 10.56 | 1.8 | OK | OK | OK |
| 32 | 277 | 90 | 69 | 0 | 10.39 | 1.8 | OK | OK | OK |

### Example 4

Similar to Example 3, the testing protocol included 1) mixing brines, 2) filtrating the brine, 3) add HEDTA chelant, 4) divide samples into two for static aging (one at ambient temperature and one at 38 F, 5) observe initially (within 10 minutes) and after 16 and 24 hrs static aged at ambient temperature and 38 F particularly for crystal or precipitation at initial and 24 static aging at room temperature, 6) measure weight of filtrate (if present), 7) add calcium carbonate available from M-I SWACO into samples that show compatibility at all temperatures, 8) observe for any reaction, and 9) measure weight of filtrate (if present) and pH after 4, 16, and 24 hours. The mixture compositions and results are shown in Tables 5 and 6 below for CaCl₂, Tables 7 and 8 for CaBr₂, and Tables 9 and 10 for ZnBr₂.

TABLE 5

| | | 11.6 lb/gal | | | | |
|---|---|---|---|---|---|---|
| | | CaCl2 | | | | |
| | Water | Brine | HEDTA | Density | pH | |
| Test | (lb/bbl) | (lb/bbl) | (lb/bbl) | (lb/gal) | (24 hr) | Obs. |
| 33 | 0.65 | 0 | 0.35 | 8.92 | 4.2 | OK |
| 34 | 0.65 | 0.07 | 0.28 | 9.02 | 2.9 | OK |
| 35 | 0.65 | 0.13 | 0.22 | 9.13 | 2.4 | OK |
| 36 | 0.65 | 0.20 | 0.15 | 9.24 | 2.2 | OK |
| 37 | 0.43 | 0.22 | 0.35 | 9.63 | 2.2 | OK |
| 38 | 0.43 | 0.28 | 0.28 | 9.73 | 2 | OK |
| 39 | 0.43 | 0.35 | 0.22 | 9.84 | 1.8 | OK |
| 40 | 0.43 | 0.42 | 0.15 | 9.94 | 1.7 | OK |
| 41 | 0.22 | 0.43 | 0.35 | 10.33 | 1.7 | OK |
| 42 | 0.22 | 0.50 | 0.28 | 10.44 | 1.5 | OK |
| 43 | 0.22 | 0.57 | 0.22 | 10.55 | 1.4 | OK |
| 44 | 0.22 | 0.63 | 0.15 | 10.65 | 1.2 | OK |
| 45 | 0 | 0.65 | 0.35 | 11.04 | 1.2 | OK |
| 46 | 0 | 0.72 | 0.28 | 11.15 | 1 | OK |
| 47 | 0 | 0.78 | 0.22 | 11.25 | 0.9 | OK |
| 48 | 0 | 0.85 | 0.15 | 11.36 | 0.8 | OK |

TABLE 6

| | | | | Amount of CaCO3 Dissolved | | |
|---|---|---|---|---|---|---|
| | pH of Breaker Fluid + CaCO3 | | | By 1 bbl of Breaker Fluid (lbs) | | |
| Test | 4 hr | 16 hr | 72 hr | 4 hr | 16 hr | 72 hr |
| 33 | 4.4 | 6.5 | 7.0 | 14.2 | 23.3 | 23.5 |
| 34 | 4.9 | 5.1 | 5.6 | 11.3 | 13.7 | 14.7 |
| 35 | 4.7 | 5 | 5.5 | 10.9 | 13.3 | 13.4 |
| 36 | 4.5 | 4.8 | 5.3 | 10.6 | 12.2 | 12.1 |
| 37 | 3.9 | 4.0 | 4.6 | 13.7 | 21.2 | 21.9 |
| 38 | 3.7 | 3.8 | 4.3 | 9.4 | 14.8 | 15.5 |
| 39 | 3.8 | 4.1 | 4.5 | 12.6 | 13.9 | 13.8 |
| 40 | 3.7 | 4.0 | 4.4 | 9.2 | 9.9 | 10.0 |
| 41 | 3.0 | 3.2 | 3.7 | 13.9 | 23.0 | 23.8 |
| 42 | 2.9 | 3.1 | 3.5 | 11.5 | 15.1 | 15.5 |
| 43 | 2.8 | 2.9 | 3.3 | 8.2 | 9.8 | 10.0 |
| 44 | 2.7 | 2.8 | 3.2 | 5.7 | 4.9 | 5.2 |
| 45 | 2.3 | 2.6 | 3.2 | 11.3 | 24.4 | 24.3 |
| 46 | 2.1 | 2.4 | 2.9 | 8.4 | 15.2 | 15.6 |
| 47 | 1.9 | 2.0 | 2.9 | 6.2 | 9.7 | 10.1 |
| 48 | 1.9 | 1.8 | 2.4 | 4.3 | 6.3 | 6.5 |

TABLE 7

| | | 14.2 lb/gal | | | | |
|---|---|---|---|---|---|---|
| | | CaBr2 | | | | |
| | Water | Brine | HEDTA | Density | pH | |
| Test | (lb/bbl) | (lb/bbl) | (lb/bbl) | (lb/gal) | (24 hr) | Obs. |
| 49 | 0.65 | 0 | 0.35 | 8.92 | 4.01 | OK |
| 50 | 0.65 | 0.07 | 0.28 | 9.20 | 2.83 | OK |
| 51 | 0.65 | 0.13 | 0.22 | 9.48 | 2.43 | OK |
| 52 | 0.65 | 0.20 | 0.15 | 9.76 | 2.17 | OK |
| 53 | 0.43 | 0.22 | 0.35 | 10.19 | 2.20 | OK |
| 54 | 0.43 | 0.28 | 0.28 | 10.47 | 2.01 | OK |
| 55 | 0.43 | 0.35 | 0.22 | 10.75 | 1.81 | OK |
| 56 | 0.43 | 0.42 | 0.15 | 11.03 | 1.66 | OK |
| 57 | 0.22 | 0.43 | 0.35 | 11.46 | 1.65 | OK |
| 58 | 0.22 | 0.50 | 0.28 | 11.74 | 1.50 | OK |
| 59 | 0.22 | 0.57 | 0.22 | 12.02 | 1.35 | OK |
| 60 | 0.22 | 0.63 | 0.15 | 12.30 | 1.20 | OK |
| 61 | 0 | 0.65 | 0.35 | 12.73 | 1.13 | OK |
| 62 | 0 | 0.72 | 0.28 | 13.01 | 0.97 | OK |
| 63 | 0 | 0.78 | 0.22 | 13.29 | 0.81 | OK |
| 64 | 0 | 0.85 | 0.15 | 13.57 | 0.65 | OK |

TABLE 8

| | | | | Amount of CaCO3 Dissolved | | |
|---|---|---|---|---|---|---|
| | pH of Breaker Fluid + CaCO3 | | | By 1 bbl of Breaker Fluid (lbs) | | |
| Test | 4 hr | 16 hr | 72 hr | 4 hr | 16 hr | 72 hr |
| 49 | 5.9 | 6.01 | 6.6 | 12.4 | 20.4 | 21.5 |
| 50 | 4.8 | 4.95 | 5.5 | 11.4 | 15.0 | 15.6 |
| 51 | 4.4 | 4.57 | 5.2 | 7.2 | 13.2 | 14.1 |
| 52 | 4.1 | 4.29 | 5.0 | 4.1 | 7.7 | 8.2 |
| 53 | 3.9 | 4.05 | 4.5 | 15.6 | 21.2 | 22.3 |
| 54 | 3.7 | 3.81 | 4.2 | 11.2 | 14.3 | 14.8 |
| 55 | 3.5 | 3.51 | 3.9 | 8.2 | 11.3 | 11.9 |
| 56 | 3.3 | 3.49 | 4.2 | 5.0 | 7.4 | 7.6 |
| 57 | 2.9 | 3.34 | 3.9 | 12.2 | 16.1 | 16.9 |
| 58 | 2.9 | 3.28 | 3.7 | 10.7 | 13.0 | 13.7 |
| 59 | 2.8 | 3.04 | 3.5 | 7.6 | 12.3 | 12.6 |
| 60 | 2.7 | 2.91 | 3.5 | 6.2 | 7.3 | 7.5 |
| 61 | 2.2 | 2.57 | 3.2 | 12.9 | 25.1 | 25.7 |
| 62 | 2.2 | 2.58 | 3.0 | 11.9 | 39.5 | 41.3 |
| 63 | 1.9 | 2.49 | 2.9 | 8.7 | 26.3 | 27.6 |
| 64 | 1.7 | 2.45 | 2.6 | 5.3 | 18.5 | 19.1 |

TABLE 9

| | | 19.2 lb/gal | | | | |
|---|---|---|---|---|---|---|
| | | ZnBr2 | | | | |
| | Water | Brine | HEDTA | Density | pH | |
| Test | (lb/bbl) | (lb/bbl) | (lb/bbl) | (lb/gal) | (24 hr) | Obs. |
| 65 | 0.65 | 0 | 0.35 | 8.92 | 4.05 | OK |
| 66 | 0.65 | 0.07 | 0.28 | 9.53 | 0.67 | OK |
| 67 | 0.65 | 0.13 | 0.22 | 10.14 | 0.21 | OK |
| 68 | 0.65 | 0.20 | 0.15 | 10.76 | 0.05 | OK |
| 69 | 0.43 | 0.22 | 0.35 | 11.27 | 0.04 | OK |
| 70 | 0.43 | 0.28 | 0.28 | 11.88 | −0.08 | OK |
| 71 | 0.43 | 0.35 | 0.22 | 12.50 | −0.16 | OK |
| 72 | 0.43 | 0.42 | 0.15 | 13.11 | −0.17 | OK |
| 73 | 0.22 | 0.43 | 0.35 | 13.63 | −0.26 | OK |
| 74 | 0.22 | 0.50 | 0.28 | 14.24 | −0.38 | OK |
| 75 | 0.22 | 0.57 | 0.22 | 14.85 | −0.48 | OK |
| 76 | 0.22 | 0.63 | 0.15 | 15.47 | −0.43 | OK |
| 77 | 0 | 0.65 | 0.35 | 15.98 | −0.71 | OK |
| 78 | 0 | 0.72 | 0.28 | 16.59 | −0.91 | OK |
| 79 | 0 | 0.78 | 0.22 | 17.21 | N/A | OK |
| 80 | 0 | 0.85 | 0.15 | 17.82 | N/A | OK |

TABLE 10

| | | | | Amount of CaCO3 Dissolved | | |
|---|---|---|---|---|---|---|
| | pH of Breaker Fluid + CaCO3 | | | By 1 bbl of Breaker Fluid (lbs) | | |
| Test | 4 hr | 16 hr | 72 hr | 4 hr | 16 hr | 72 hr |
| 65 | 5.8 | 6.05 | 6.74 | 11.5 | 19.8 | 20.7 |
| 66 | 4.53 | 4.75 | 5.31 | 13.2 | 16.2 | 16.9 |
| 67 | 4.21 | 4.40 | 4.9 | 8.4 | 12.0 | 12.5 |
| 68 | 3.89 | 4.05 | 4.51 | 3.4 | 6.3 | 6.8 |
| 69 | 3.72 | 3.82 | 4.25 | 19.3 | 23.9 | 24.6 |
| 70 | 3.62 | 3.69 | 4.08 | 9.9 | 11.5 | 11.8 |
| 71 | 3.47 | 3.55 | 3.89 | 7.5 | 8.9 | 9.4 |
| 72 | 3.20 | 3.30 | 3.69 | 3.6 | 5.2 | 5.8 |
| 73 | 2.99 | 3.07 | 3.54 | 11.4 | 15.7 | 15.8 |
| 74 | 2.79 | 2.87 | 3.26 | 6.7 | 11.1 | 11.2 |
| 75 | 2.58 | 2.62 | 3.02 | 4.7 | 11.0 | 11.1 |
| 76 | 2.35 | 2.47 | 2.82 | 2.8 | 4.4 | 4.7 |
| 77 | 2.15 | 2.18 | 2.59 | 10.7 | 18.8 | 19.9 |
| 78 | 1.72 | 1.88 | 2.29 | 7.6 | 15.9 | 17.3 |
| 79 | 1.45 | 1.47 | 1.77 | 4.3 | 10.4 | 12.2 |
| 80 | 0.99 | 1.11 | 1.53 | 1.3 | 6.2 | 7.2 |

### Example 5

Two reservoir drilling fluid (RDF) samples were mixed and used, formulated as shown in Table 11 below. RDF samples were differentiated with the presence and absence of a surface tension reducer. Viscosity of the samples were measured using FANN-35 viscometer and modified HTHP fluid loss devices, and the results are shown in Table 12.

TABLE 11

| | Test | |
|---|---|---|
| | | 82 (w/surface tension |
| | 81 (Base) | reducer |
| Component | lbs/bbl | |
| 12.5 NaBr Brine | 445.0 | 460 |
| Water | 9.8 | N/A |
| Defoamer | 0.1 | 0.5 |
| Modified starch | 7.0 | 7.0 |
| Mg compound | 0.25 | 0.25 |
| Polyglycol for wellbore | 10.5 | 10.5 |
| stability | | |
| surface tension reducer | N/A | 1.75 |
| Sized CaCO₃ 2 | 4.4 | 4.1 |
| Sized CaCO₃ 10 | 8.8 | 8.2 |
| Sized CaCO₃ 20 | 88.0 | 81.5 |
| Sized CaCO₃ 40 | 8.8 | 8.2 |

TABLE 12

| | Example | | | |
|---|---|---|---|---|
| | 81 (Base) | | 82 (w/FLOWBAK) | |
| Aging Time (hr.) | Initial | 16 | Initial | 16 |
| Aging Mode | | Dynamic | | Dynamic |
| Aging Temp. (° F.) | | 230 | | 230 |
| FANN-35 Test Temp. (° F.) | 120 | 120 | 120 | 120 |
| 600 RPM | 64 | 59 | 54 | 60 |
| 300 RPM | 46 | 42 | 39 | 46 |
| 200 RPM | 39 | 35 | 33 | 40 |
| 100 RPM | 30 | 26 | 26 | 33 |
| 6 RPM | 15 | 13 | 14 | 14 |
| 3 RPM | 14 | 11 | 13 | 12 |
| Gel 10 Sec. (lb/100 ft²) | 15 | 11 | 13 | 12 |
| Gel 10 min. (lb/100 ft²) 0.3 | 19 | 13 | 16 | 15 |
| RPM @ 3 Min. (LSRV) | | | | |
| (cP) | | | | |
| PV (cP) | 18 | 16 | 15 | 14 |
| YP (lb/100 ft²) | 28 | 26 | 24 | 32 |

FAO-05 aloxite discs were used to simulate the formation. The permeability of virgin discs were measured, and filter cakes were deposited on the discs during 4 hours at 500 psi and 230° F. After formation of the filter cake, 13.80 lb/gal filter cake breaker systems (shown in Table 13) were applied for a soaking period of 3 days. The breakthrough times were recorded before close the bottom valve of HPHT cell. The soak time began when the breaker contacts the filter cake until the return flow is measured. Finally the permeability of disk after treatment was measured. The results of the tests are shown in Table 14.

TABLE 13

| | Test | |
|---|---|---|
| | 83 | 84 |
| Component | lbs/bbl | |
| 19.2 lb/gal ZnBr2 Brine | 390 | 371 |
| Water | 73.9 | 73.5 |
| H-EDTA | 115.7 | 126 |
| SAFE-VIS | N/A | 10 |
| Fluid Properties | | |
| Brine Density | 14.97 | 15.46 |
| Final Density | 13.80 | 13.80 |
| pH Initial | 2.4 | 2.4 |
| pH Final | 1.8 | 2.0 |

TABLE 14

| Example | | 81 with 83 | 82 with 83 | 81 with 84 |
|---|---|---|---|---|
| Initial Flow | | | | <0.5 |
| Pressure | | | | |
| Return Flow | (psi) | (%) | (%) | (%) |
| | 2 | 62.8 | 77.4 | 74.0 |
| | 3 | 74.9 | 89.2 | 86.8 |
| | 4 | 80.1 | 90.1 | 91.7 |
| | 5 | 84.3 | 92.9 | 97.2 |
| | 8 | 89.1 | 96.3 | 97.3 |
| | 10 | | | 97.3 |

Although the preceding description has been described herein with reference to particular means, materials, and embodiments, it is not intended to be limited to the particulars disclosed herein; rather, it extends to all functionally equivalent structures, methods and uses, such as are within the scope of the appended claims.

What is claimed is:

1. A method comprising:
circulating a pre-mixed wellbore fluid into the wellbore, the pre-mixed wellbore fluid comprising:
a brine containing divalent cations; and
a (2-hydroxyethyl)ethylenediaminetriacetic acid (HEDTA) chelant.

2. The method of claim 1, wherein the divalent cations are provided by at least one of CaCl₂, CaBr₂, and ZnBr₂.

3. The method of claim 2, wherein a density of the breaker fluid is about 5% below saturation point of the divalent cations.

4. The method of claim 2, wherein the brine has divalent cations of CaCl₂ and a density below about 11.5 lb/gal.

5. The method of claim 2, wherein the brine has divalent cations of CaBr₂ and a density below about 14.1 lb/gal.

6. The method of claim 2, wherein the brine has divalent cations of ZnBr₂ and a density below about 19.0 lb/gal.

7. The method of claim 1, wherein the amount of HEDTA chelant in the pre-mixed wellbore fluid is from about 5 volume % to about 35 volume %.

8. The method of claim 1, wherein pH of the wellbore fluid ranges from about 0 to 5.

9. The method of claim 1, wherein the filter cake comprises calcium carbonate particles.

10. A method of breaking a filter cake in a wellbore, the method comprising:
drilling a wellbore with a drilling fluid that includes a divalent brine, thereby forming a filter cake including the divalent brine therein; and
circulating a breaker fluid into the wellbore, the breaker fluid comprising:
a (2-hydroxyethyl)ethylenediaminetriacetic acid (HEDTA) chelant.

11. The method of claim 10, wherein the filter cake comprises calcium carbonate particles.

12. The method of claim 10, wherein the divalent brine are provided by at least one of CaCl₂, CaBr₂, and ZnBr₂.

13. The method of claim 12, wherein the density of the breaker fluid is about 5% below the saturation point of the divalent cations.

14. The method of claim 10, wherein the brine comprises CaCl₂ and has a density below about 11.5 lb/gal.

15. The method of claim 10, wherein the brine comprises CaBr₂ and has a density below about 14.1 lb/gal.

16. The method of claim 10, wherein the brine comprises ZnBr₂ and has a density below about 19.0 lb/gal.

17. The method of claim 10, wherein the amount of HEDTA chelant in the breaker fluid is from about 5 volume % to about 35 volume %.

18. The method of claim 10, wherein the pH of the breaker fluid ranges from about 0 to 5.

19. A breaker fluid comprising:
a brine containing divalent cations; and
a (2-hydroxyethyl)ethylenediaminetriacetic acid (H-EDTA) chelant.

20. The breaker fluid of claim 19, wherein the amount of HEDTA chelant in the breaker fluid is from about 5 volume % to about 35 volume %.
